(19) United States
(12) Patent Application Publication
(10) Pub. No.: US 2006/0042475 A1
(43) Pub. Date: Mar. 2, 2006

(54) Removable Radiant Heat Baffle for Barbeque Grills

(75) Inventor: Philip Joel Craig, Winter Springs, FL (US)

Correspondence Address: PHILIP J. CRAIG, 1508 EAGLE NEST CIRCLE, WINTER SPRINGS, FL, 32708, US

(73) Assignee: CRAIG HOLDINGS INCORPORATED, Winter Springs, FL (US)

(21) Appl. No.: 11/161,713

(22) Filed: Aug. 13, 2005

Related U.S. Application Data
(60) Provisional application No. 60/604,059, filed on Aug. 24, 2004.

(51) Int. Cl. A01J 11/04

(52) U.S. Cl. 99/467

(57) ABSTRACT

The Radiant Heat Baffle is a removable device which converts a conventional barbeque grill into a smoker by modifying the grill's heat transfer characteristics. The device blocks the primary radiant heat transfer pathway, extends the conductive heat transfer pathways and allows convection heating as the primary means of cooking. The device compartmentalizes the fuel, provides sufficient air flow to sustain combustion and the utility to conveniently add fuel during the cooking process.

Barbeque experts generally agree that the most flavorful and tender barbequed meat is slow cooked at low temperatures. Barbeque cooking devices fall into two general categories, grills and smokers. The barbeque grill is designed to quickly cook meats at high temperatures and is ideal for tender cuts of meat. By comparison, the smoker is designed to slowly cook meats at a much lower temperature. While grill manufacturers claim that indirect heating methods can be used in their grill designs to slowly cook and smoke meats, in practice it is very difficult because of the heat transfer characteristics of the grill design and the current state of the art in grill accessories.

Heat energy is transferred from a hot body to cold body by a combination of three methods: radiation, conductance and convection. A typical barbeque grill utilizes all three forms of heat transfer to cook food. Whereas a barbeque smoker is designed to utilize convection heat transfer as the primary means of cooking.

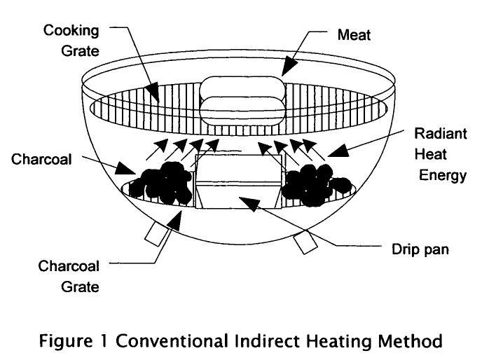

The current state of the art for indirect heating methods for a barbeque grill is to separate the charcoal into two areas and insert a drip pan in between. Heat is transferred by radiation from a hot body in a straight line in every direction. In the case of the conventional indirect heating method, radiant heat energy is transferred directly to the cooking food as shown in FIG. 1. Convection heat energy is also transferred to the food by air heated while passing through the burning charcoal and circulated around the food. Finally, the cooking grate is heated by both radiation and convection energy. The metal cooking grate conducts the heat to the cooking food by means of conduction.

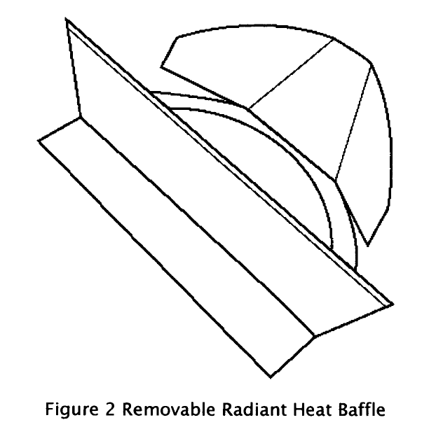

The Radiant Heat Baffle (FIG. 2) is a removable device that can convert a barbeque grill into an efficient smoker.

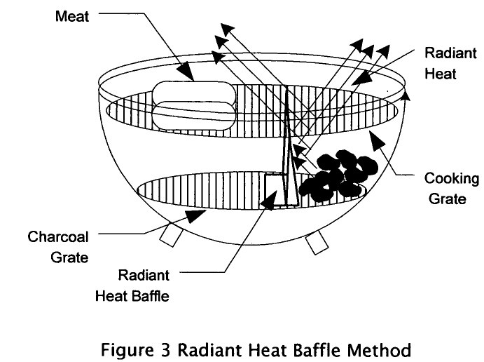

The radiant heat baffle, FIG. 3, creates a barrier which blocks the direct transmission path of the radiant energy preventing it from reaching the cooking food. The grill lid absorbs much of the radiant energy and reflects a relatively small portion of the energy back into the cooking food. Most of the radiant heat is absorbed by the lid, transferred by conductance through the metal lid and released into the atmosphere in the form of convection and radiant heat energy. Conductive heat transfer through the cooking grate is also greatly reduced because of the reduced surface area available to absorb heat energy and the longer transmission path to the cooking food.

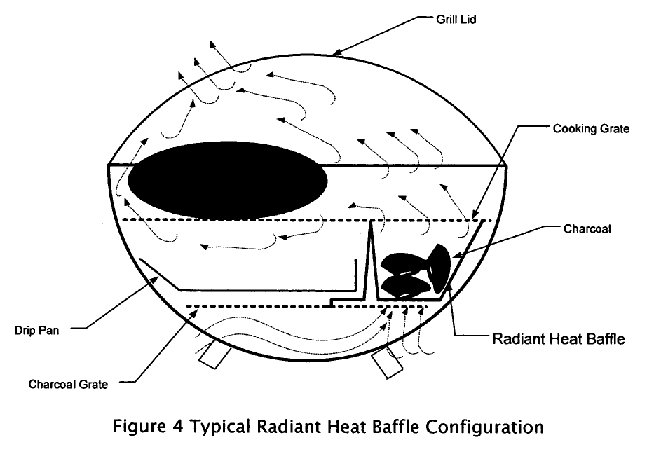

A typical Radiant Heat Baffle configuration is shown in FIG. 4. The device is configured to fit between the fuel grate and the cooking grate of a barbeque grill. The device compartmentalizes a heating fuel, such as charcoal, into a small area on one side of the grill. The device has a passageway that allows air entering the grill beneath the charcoal grate to pass through the device to sustain the fuel combustion and act as the media for convection heating of the cooking food. The device has dual barrier walls that rise from the charcoal grate to within close proximity of the cooking grate and extend the entire width of the grill. These barrier walls block the radiant heat transfer pathway between the fuel and the cooking food. The dual wall construction provides a dead air space between the walls that reduces the wall temperature of the device facing the cooking food. The extended pathway of the dual wall construction reduces the conductive heat transfer.

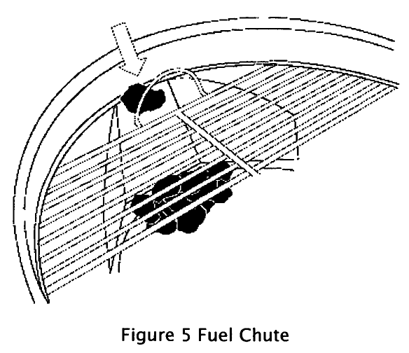

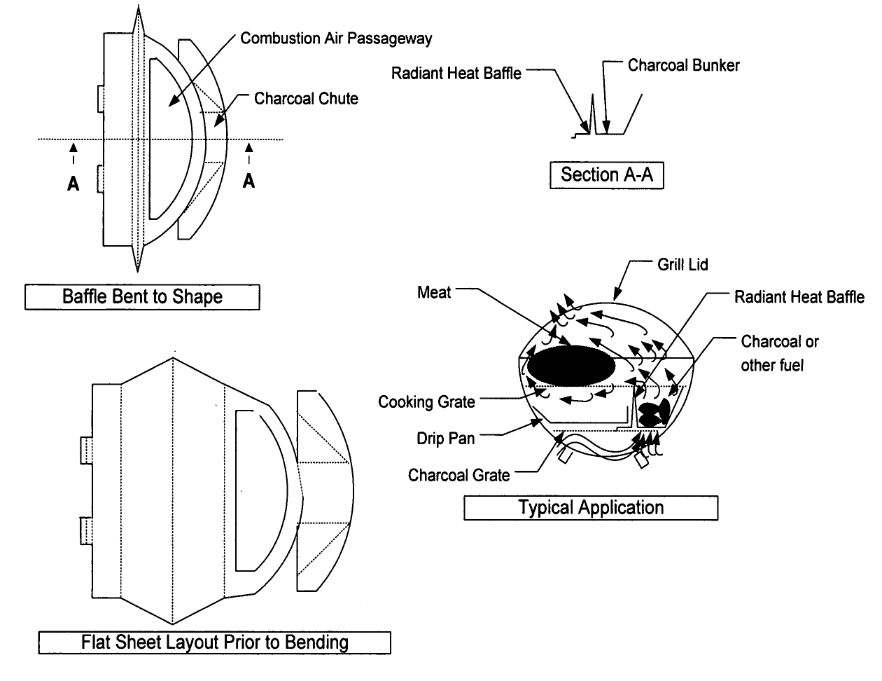

The device is configured to provide a fuel chute, FIG. 5, which allows the easy addition of fuel through the cooking grate handle cut outs. Temperature losses occur when the barbeque grill lid is removed to add fuel or baste during the lengthy cooking period. The longer the lid is removed the more heat loss occurs and the longer it takes for the barbeque to reach the appropriate temperature. The fuel chute allows for rapid fuel addition and therefore minimizes the heat loss and cooking time.

Variations in the device shape or form are contemplated for the different varieties of barbeque grills manufactured. The device may be constructed from ceramic or metal materials.

The preferred material composition is sheet metal that is cut or stamped to a defined shape and then bent into the contemplated form. The material contemplated is thermally and corrosively resistant while benign to the food being prepared.

What is claimed is:

1. I claim a removable device for insertion In a barbeque grill which modifies the heat transfer characteristics converting the grill into a convection smoker by; (i) creating a barrier to reduce radiant heat transfer, and (ii) reducing conductive heat transfer by extending the transmission pathways, while (iii) permitting convection heating of the cooking food.

2. I claim a barbeque grill design which contains a removable device which alters the heat transfer characteristics converting the grill to a convection smoker by; (i) creating a barrier to reduce radiant heat transfer, and (ii) reducing conductive heat transfer by extending the transmission pathway, while (iii) permitting convection heating of the cooking food.
